(19) United States
(12) Patent Application Publication
(10) Pub. No.: US 2018/0069499 A1
(43) Pub. Date: Mar. 8, 2018

(54) METHOD FOR CONTROLLING A SYNCHRONOUS GENERATOR OF A GEARLESS WIND ENERGY TURBINE

(71) Applicant: Wobben Properties GmbH, Aurich (DE)

(72) Inventors: Sönke ENGELKEN, Bremen (DE); Christian STRAFIEL, Aurich (DE); Wojciech GIENGIEL, Aurich (DE); Stefan GERTJEGERDES, Aurich (DE)

(21) Appl. No.: 15/559,765

(22) PCT Filed: Mar. 23, 2016
(86) PCT No.: PCT/EP2016/056375

§ 371 Date: Sep. 19, 2017

(30) Foreign Application Priority Data
Mar. 24, 2015 (DE) 10 2015 205 348.2

(51) Int. Cl. H02P 21/13; H02P 25/22; H02P 6/10; H02P 9/02

(52) U.S. Cl. CPC H02P 21/13; H02P 25/22; H02P 2101/15; H02P 9/02; H02P 6/10

(57) ABSTRACT

A method for controlling a synchronous generator of a gearless wind turbine is disclosed. The synchronous generator has an electrodynamic rotor and a stator for producing electrical power by rotating the rotor relative to the stator. The method includes generating a multiphase output current at the stator, supplying the output current to a rectifier, and controlling the output current using the rectifier in such a manner that a torque ripple of the generator is reduced.

### BACKGROUND

### Technical Field

The present invention relates to a method for controlling a synchronous generator of a gearless wind turbine. The present invention also relates to a generator unit having a synchronous generator of a gearless wind turbine and a rectifier connected thereto. The present invention also relates to a wind turbine.

### Description of the Related Art

Wind turbines are known. They produce electrical energy from wind. For this purpose, many modern wind turbines use a synchronous generator which, driven by the wind, generates an alternating current. This alternating current is rectified and is fed into an electrical supply network via an inverter.

In this case, gearless wind turbines drive the synchronous generator, more precisely its rotor, directly by means of an aerodynamic rotor which has rotor blades and is driven by the wind. Accordingly, the rotor of the generator rotates at the same speed as the aerodynamic rotor, namely comparatively slowly. In this case, the speed may be approximately in the range of 5 to 15 revolutions per minute. Accordingly, a generator having a very large number of poles is provided. This generator is preferably in the form of a ring generator and therefore has the electrically and electromagnetically effective areas only on an annular section which also comprises the air gap.

Such a generator of a gearless wind turbine usually has a diameter in the range of 5 meters (m). Some specimens, for example a wind turbine of the E126 type from ENERCON GmbH, even have an annular gap diameter of approximately 10 m. Such generators often determine at least the approximate size of the nacelle of the wind turbine. In this case, these generators may produce noise which they may accordingly also emit to the environment on account of the size thereof and which they may also emit, which may often be the larger proportion, to the environment via elements connected thereto such as the nacelle cladding or spinners and rotor blades. Such noise generation is undesirable in principle. Even though this noise is emitted at a comparatively high height above the ground, it may also nevertheless be distinctly perceived on the ground in the vicinity of the wind turbine. Accordingly, there are requirements to keep wind turbines as far away from populated areas and other areas used by people as possible. As a result of these requirements for increased distances, the possible areas for erecting wind turbines are dwindling and the erection of wind turbines is therefore becoming increasingly more difficult.

The German Patent and Trade Mark Office researched the following documents in the priority-establishing German patent application: US 2003/0085627 A1 and WO 2013/175050 A1.

### BRIEF SUMMARY

A solution for reducing the sound emission of wind turbines is provided. At least an alternative solution in comparison with previously known solutions is provided.

A method for controlling a synchronous generator of a gearless wind turbine is provided. In this case, the synchronous generator has an electromagnetic rotor, or simply rotor, coupled to the aerodynamic rotor and a stator for producing electrical power. Power is produced by virtue of the rotor being rotated relative to the stator. The term “rotor” is used below to denote the rotor of the generator.

A multiphase output current is then generated at the stator and this output current is supplied to the rectifier. It is now proposed for the output current to be controlled by means of the rectifier in such a manner that a torque ripple of the generator is reduced. The rectifier, therefore, controls the output current at the stator and, therefore, controls the stator current as a result. For this purpose, the rectifier has controlled diodes or controlled semiconductor switches, with the result that the output current from the stator can be controlled, and the control being carried out in such a manner that a torque ripple of the generator is reduced.

A torque ripple also includes cogging torques, which result when a rotor pole, during rotation of the rotor, passes through transitions from one stator tooth to the next. In addition to cogging torques, there is a further effect caused by a rotor flux which is not sinusoidal in stator coordinates.

This torque ripple also depends on the relevant instantaneous stator current. It is now proposed to accordingly control the stator current in such a manner that the harmonic content is counteracted. Ideally, it is reduced to zero. Expressed in an illustrative and simplifying manner, the stator current is controlled in such a manner that a reciprocal harmonic content is superimposed on it. Cogging torques may also be additionally compensated for in a targeted manner if they are known. Torque fluctuations nevertheless remain and must be recorded and taken into account.

Such influence of the stator current and, therefore, of the magnetic field in the stator can be influenced by accordingly controlling the rectifier. This should not have any influence or any significant influence on the overall energy balance because corresponding superimpositions of the stator current should be approximately averaged out.

A current waveform is, therefore, preferably impressed on the output current, that is to say the output current from the stator, as a result of this control by the rectifier. A harmonic content, in particular, is impressed on said current. The stator current is ideally sinusoidal. The current waveform for a uniform torque depends on the design of the generator and on the operating point. As a result of the fact that the transitions between the stator teeth are not ideal, the described harmonic content results with an ideal sinusoidal stator current. If, expressed in a simplified manner, a reciprocal harmonic content is now impressed on the stator current, it can compensate for the harmonic content caused by the transitions from one stator tooth to the next. However, if this ideal compensation cannot be achieved, it should at least be possible to reduce the torque harmonic content as a result.

According to one embodiment, the synchronous generator is in the form of a six-phase generator and the rectifier is in the form of a six-phase controlled rectifier. It is, therefore, possible to control a six-phase system in this case. This six-phase system is preferably in the form of two three-phase systems which have been phase-shifted by 30° relative to one another. In this case, the two three-phase systems may be DC-isolated in the stator, in particular. However, they are provided, in particular wound, on the same stator and may supply the same DC intermediate circuit to the rectifier. In particular, however, both three-phase systems and, therefore, the six-phase system should preferably be taken into account as an overall system during control. Accordingly, the six-phase controlled rectifier is provided herein. In particular, the rectifier can impress a corresponding current waveform on the output current from the stator, that is to say the six-phase output current, by means of the accordingly controlled rectification. In this respect, a six-phase current can be understood as meaning a system consisting of six individual currents which are correspondingly related to one another just with respect to their sinusoidal fundamental, namely are shifted by a multiple of 30° with respect to one another.

According to one configuration, the basis is the magnetic flux of the rotor, which can be referred to as the rotor flux, and possibly also the overall flux of the stator or the machine, which can be referred to as the stator flux in a simplifying manner. In this case, it is proposed for the output current, that is to say the output current from the stator, to be controlled on the basis of the magnetic flux of the rotor, that is to say the rotor flux. The magnetic flux of the rotor or rotor flux is, therefore, at least an input variable for this control for reducing the torque ripple. In this case, the rotor flux is also used, in particular, to control the output current from the six-phase synchronous generator or six-phase rectifier. The output current can also be actually controlled for the six-phase system for reducing the torque ripple as a result of the proposed method, in particular also as a result of the use of the rotor flux.

In this case, one configuration proposes for the rotor flux to be observed by using a state observer in order to control the output current. The output current, that is to say the stator current, is then controlled on the basis of the observed rotor flux.

The problem of using the rotor flux is that it cannot be easily measured. In addition, if the rotor flux can be measured or is measured, problems may occur with the accuracy; the temporal accuracy, in particular, is important in this case. Quite apart from the outlay on apparatus which would be necessary, physical effects of the measurement and of the evaluation of the measurement may give rise to problems when used in control. Accordingly, a state observer is proposed herein. This state observer may observe the corresponding states, namely the rotor flux here, in particular. This means that the state observer can determine the rotor flux from knowledge of the system and further input variables, possibly only one further input variable.

One possibility which can vividly explain at least one principle of a state observer involves the state observer being constructed in such a manner that it operates a model which is parallel to the system to be observed and describes the system. By comparing at least one output variable of the system with the corresponding output variable of the model, an attempt is made to match the states of the model, which are the observed states of the system, to the actual states of the system as far as possible. In particular, this means that the states observed in this manner, namely components of the observed rotor flux in particular, do not lag behind the actual states, that is to say the components of the actual rotor flux. Accordingly, the control can also be carried out accurately in terms of time.

In this case, it should be recalled that the output current from the stator is intended to be controlled in such a manner that, expressed in a simplified manner, the harmonic content of the torque is intended to be compensated for as much as possible, in particular is intended to be compensated for by, accordingly, reciprocally applying a corresponding current waveform. If such application of an accordingly rippled current signal would not be sufficiently accurate in terms of time, there would even be a risk of the torque ripple even being able to increase further. This is avoided by using the state observer.

One preferred embodiment proposes for the generator to have six phases, namely with a stator having double star connection with star points which are not connected. Two three-phase systems are therefore provided in the stator and are each connected in a star per se. The two star points are not connected; in particular, they are also not indirectly connected via a common zero conductor. These two three-phase systems are, therefore, also inevitably symmetrical per se.

For this purpose, during operation, the generator has a torque which is caused by the interaction of currents and fluxes, and these variables are transformed into a double D/Q system with four axes by means of a coordinate transformation. In this case, a current component and a rotor flux component are assigned to each of the four axes.

This approach is, therefore, based on a simple D/Q coordinate transformation in which a three-phase system is namely transformed into a system having two orthogonal components; namely the D component and the Q component.

In order to record this six-phase system, a transformation into two corresponding D/Q systems is accordingly proposed, which is referred to herein as a double D/Q system or a double D/Q transformation and is also explained in more detail below by way of example using the calculation rules.

In this case, a stator current component and a rotor flux component are assigned to each of the four axes which occur in this double D/Q system. There is, therefore, a first D component, a first Q component, a second D component and a second Q component both for the stator current and for the rotor flux. The stator current is referred to only as the current herein in a simplifying manner. The same analogously applies to the current components and the desired current which fundamentally relate to the stator.

In this system, a desired current vector with a desired current for each of the four axes is then predefined for the purpose of predefining a constant desired torque which should ideally be achieved, namely without harmonics. The desired current vector, therefore, has four current components; namely two current components for the first D/Q system and two current components for the second D/Q system, respectively.

This can now be used to easily predefine a desired current vector and, therefore, desired values for controlling the output current. For conversion, a back-transformation should finally also be provided, or a transformation into the corresponding switching commands or control commands for the controlled rectifier.

One embodiment proposes that, in order to control the output current, use is made of a state space representation which allows observability of a rotor flux component. Initially this means that a representation in the form of a state space representation is actually selected. The term “state space representation” or “state space description” is known to a person skilled in the art. Nevertheless, it is mentioned at this juncture that the interaction of individual, also internal state variables is described in this case, in particular, in contrast to an input/output description. This is usually carried out using a corresponding system of equations which can also be combined in a matrix notation. The rotor flux components can be selected as state variables.

In addition, the system description can also concomitantly include the stator flux components and may treat them in an analogous manner to the rotor flux components. As a result, the selected state variables, which may then comprise the rotor flux components and the stator flux components, are present in the selected system representation as corresponding system states and can be retrieved using a model which comprises these system states.

Although the observability of a system is fundamentally a system property, it can be influenced by suitably describing the system, in particular by suitably selecting the input and/or output variables. If output variables which directly and clearly depend on the system variables to be observed are selected, in particular, there may be observability. In this sense, the state space representation is, therefore, selected in such a manner that the rotor flux components form system states and can be observed.

It is preferably proposed that there is also observability of all magnetic stator flux components. It is proposed herein, in particular, that all rotor flux components and all stator flux components are used in the state space representation as system states. System states or system state variables can also be simply referred to as states herein in a simplified manner in terms of control engineering.

In this case, the representation may not be exclusively restricted to the use of rotor flux components as states or to the use of rotor flux components and stator flux components. Further system states may also be present.

Another embodiment proposes that the rotor flux components and possibly also the stator flux components are observed on the basis of the representation in the transformed double D/Q system having four axes by means of a Kalman filter. Accordingly, the rotor flux components are, therefore, selected as states and possibly additionally also the stator flux components. In both cases, this system can then be represented in the transformed double D/Q system. On the basis of this, the observation is then carried out using a Kalman filter. A state observation is, therefore, carried out, namely a determination of the corresponding state variables, that is to say the rotor flux components and possibly additionally the stator flux components, which is based on a model of the system to be observed.

The Kalman filter provides values for the system states to be observed in each case by taking into account this model, taking into account input and output variables, taking into account, in particular, a deviation or deviations of the output system or the output signals between the system, on the one hand, and the model, on the other hand, and by taking into account stochastic considerations relating to disturbance variables. On the basis of this, desired values for the stator current can be determined and can then be implemented by accordingly controlling the rectifier.

The use of a Kalman filter is proposed, in particular, for the embodiments accordingly described above, but is also proposed herein, in particular for taking into account disturbance variables, as a fundamental solution approach for the configuration of a state observer. It should be noted that the torque fluctuation to be avoided is a systematic, cyclical problem. Nevertheless, it has emerged and was recognized by the inventors that a good solution can be provided, in particular when taking into account stochastic disturbances, and the use of a Kalman filter is proposed herein as a solution.

A generator unit is disclosed. Such a generator unit has a synchronous generator of a gearless wind turbine and a rectifier connected thereto. The synchronous generator unit is prepared to control the synchronous generator by means of a method according to at least one of the embodiments described above. In this respect, the generator unit requires the synchronous generator and the rectifier, and these two elements cooperate here because the current generated, namely the stator current in particular, is generated by the synchronous generator but is influenced by the rectifier connected thereto.

The current generated can initially be controlled by this aggregate and the control of this aggregate, and it is, therefore, then also possible to reduce noise, in particular that can occur as a result of torque fluctuations. These torque fluctuations depend not least on the stator current and this influence can be carried out using said current.

A wind turbine having a generator unit is provided according to at least one embodiment. The advantages described in connection with the embodiments above are ultimately helpful for reducing torque fluctuations during operation of the generator. This also makes it possible to reduce any vibrations. Vibrations may in turn result in the generation of noise. Such noise generation or else directly the vibrations is/are transmitted, in particular, to large elements of the wind turbines and are emitted by said elements as sound. These elements may include the nacelle cladding and also the rotor blades. In this respect, it is important to reduce these fluctuations in the torque of the generator for the wind turbine overall, that is to say with the generator unit, namely with the generator and the connected inverter. The wind turbine as a whole can be rendered quieter as a result.

### BRIEF DESCRIPTION OF THE SEVERAL VIEWS OF THE DRAWINGS

The invention is explained in more detail by way of example below using embodiments with reference to the accompanying figures.

FIG. 1 schematically shows a perspective view of a wind turbine.

FIG. 2 schematically shows a structure of a supply arrangement having a synchronous generator with a rectifier connected thereto and further connection.

FIG. 3 schematically shows a further structure of a generator unit, namely a synchronous generator with a rectifier connected thereto.

FIG. 4 schematically shows an illustration of a method for controlling a synchronous generator, including the use of an observer.

### DETAILED DESCRIPTION

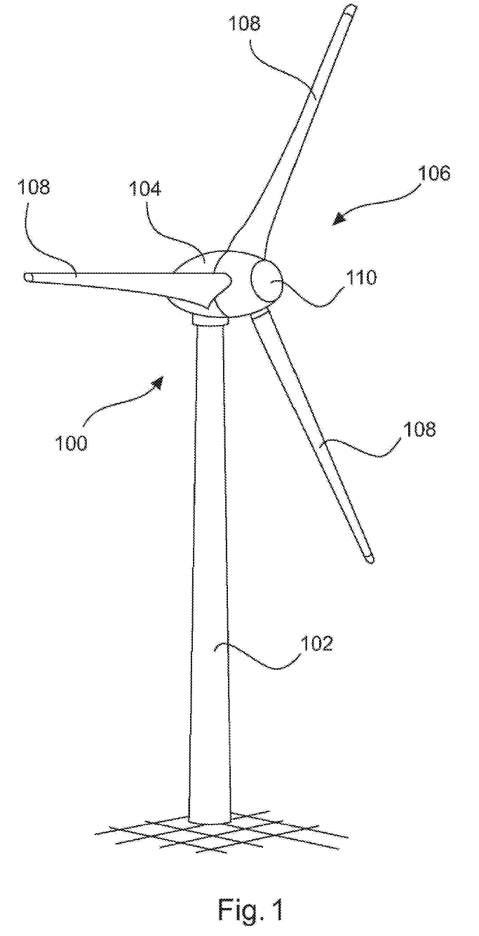

FIG. 1 shows a wind turbine 100 having a tower 102 and a nacelle 104. A rotor 106 having three rotor blades 108 and a spinner 110 are arranged on the nacelle 104. During operation, the rotor 106 is caused to carry out a rotational movement by the wind and thereby drives a generator in the nacelle 104.

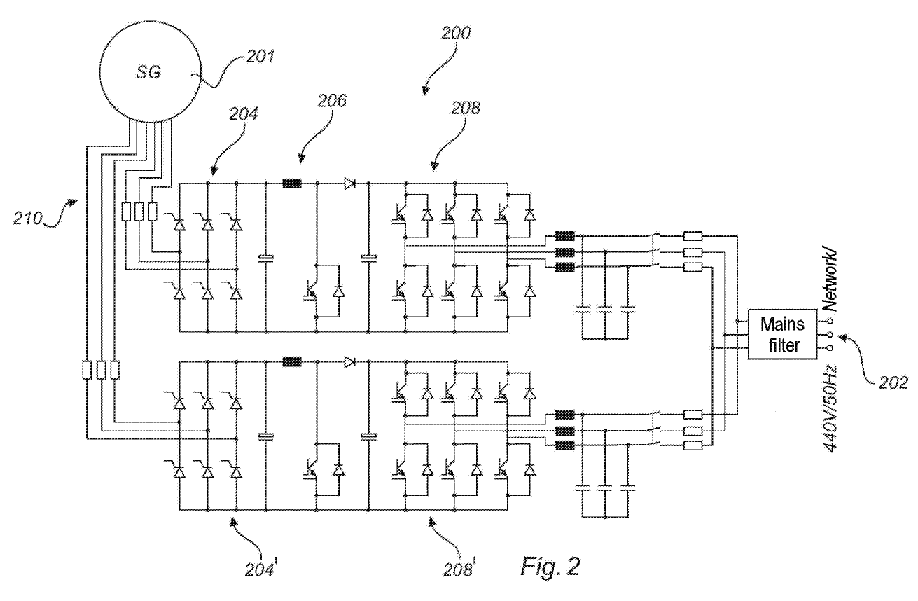

FIG. 2 shows an arrangement 200 for supplying electrical current from a synchronous generator 201 to an electrical network 202. The synchronous generator 201 is provided for this purpose in order to generate electrical current which is supplied to a rectifier unit 204 and is rectified by the rectifier unit 204. A boost converter 206 may be provided for the purpose of increasing the DC voltage produced in the process, and an inverter 208 is provided for generating an electrical alternating current.

The synchronous generator 201 shown has two three-phase systems, with the result that a total of six power lines 210 are provided, namely two of three lines in each case. The two three-phase systems are separately connected to a respective rectifier 204 and 204′ and are also separately converted into alternating current using a respective inverter 208 and 208′. However, it is preferably proposed that the two three-phase systems are combined after rectification and are connected to a single DC voltage intermediate circuit.

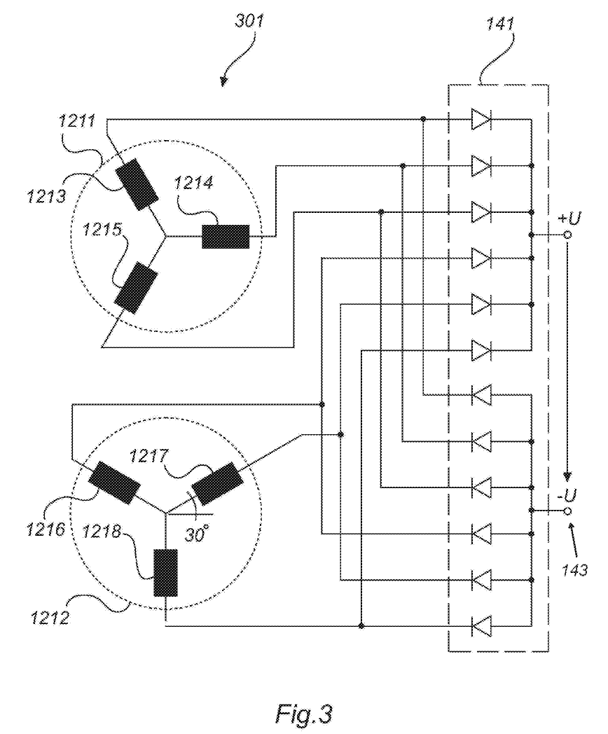

In this sense, FIG. 3 illustrates a synchronous generator 301 which likewise has two three-phase systems; namely a first three-phase system 1211 and a second three-phase system 1212. The two three-phase systems 1211 and 1212 relate to the stator of the synchronous generator 301 in this respect. They are depicted schematically here and only for illustration as separate circles, but are structurally arranged on a stator support, in particular a stator ring. For the sake of clarity here, the rotor is not illustrated and may be in the form of a multi-pole rotor with DC excitation. The two three-phase systems 1211 and 1212 of the stator are also each illustrated here with a first, a second and a third phase 1213, 1214 and 1215 and 1216, 1217 and 1218 in an illustrative manner. Each of these phases may be formed, however, by a multiplicity of windings which are connected in series, in particular. The respectively induced three-phase voltage or the resulting three-phase current is then rectified in the rectifier 141 and continues to be available to the DC voltage intermediate circuit 143 as DC voltage.

A DC voltage, namely at the DC voltage intermediate circuit 143, is, therefore, produced here from the two three-phase systems.

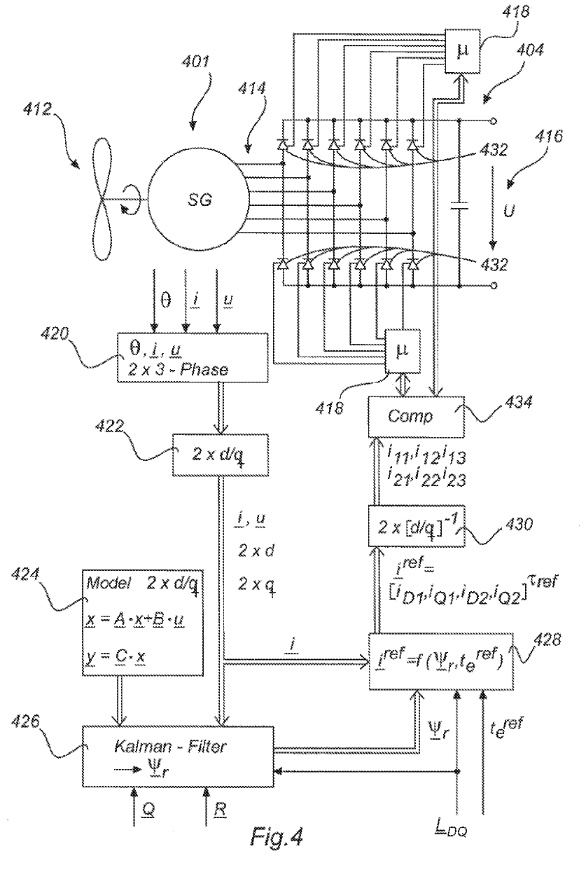

FIG. 4 now schematically illustrates a configuration of a method for controlling a synchronous generator.

The method initially starts from a synchronous generator 401, which is driven by an aerodynamic rotor 412. The synchronous generator 401 has two three-phase systems, with the result that six output lines 414 leave the generator and lead to a controlled rectifier 404. The two three-phase systems may be connected in a star in the synchronous generator 401, as is also shown in FIG. 3, for example. The rectifier 404 also corresponds to the rectifier 141 according to FIG. 3 insofar as the two three-phase systems are rectified to form a common DC voltage 416.

Two control units 418 are schematically illustrated for controlling the rectifier 404, which control units implement part of the method also described below and can also be implemented in a single control unit and in various distributed individual control units. The control units 418 may also be combined with other control units which are subsequently used, for example, to invert the DC voltage 416.

The method now operates in such a manner that the angle of rotation θ, which indicates the instantaneous rotary position of the rotor of the synchronous generator 401, is first of all recorded. The output currents and the output voltages from the synchronous generator 401 are recorded at the same time. The measuring block 420 is provided for this purpose. There, the recorded output currents are symbolized as i and the output voltages, which are to be recorded and can each be recorded as a conductor star point voltage, are symbolized as u in a simplifying manner.

The current and voltage for two three-phase systems are therefore available as measured values, and the angle of rotation 0 is available, in the measuring block 420.

These values are then transmitted to a transformation block 422 and a so-called d/q transformation is carried out for each of these two phases. The result is then a d component and a q component both for the current i and for the voltage u for each of the two three-phase systems. Therefore, there is a total of eight components for each transformation time.

At the same time or else beforehand, a fundamental model of the connected synchronous generator is provided in a state space representation in the model block 424. In comparison with a complete conventional state model, this model does not contain a D component, and, therefore, no manipulated variable u which acts directly, that is to say without dynamics, on the output y. Purely as a precaution, it is pointed out that, in the state space model and in this paragraph, the letter u does not stand for the electrical voltage u, in particular does not stand for the voltage which was measured by the measuring block 420 at the synchronous generator 401, but rather generally for a manipulated variable, and that the D component does not stand for the d component of the transformation to the d/q system.

The observer block 426 now uses the model from the model block 424 to observe the rotor flux ψᵣ as accurately as possible and with precise timing taking into account the d components and q components which it receives from the transformation block 422. In addition to the input variables and the model description, the filter matrices Q and R are used for this purpose. These matrices predefine the desired dynamics, in particular with which an observation error is intended to be corrected, and take into account the expected disturbance behavior and the expected disturbances. A Kalman filter is, therefore, implemented in the observer block 426. This filter observes or determines the rotor flux ψᵣ, but may also concomitantly observe further variables, in particular also the stator flux ψᵣ, by means of corresponding model expansion in the model block 424.

On the basis of this, the parameterization of the Kalman filter, in particular the filter matrices Q and R, can then be designed in a known manner, in particular by solving corresponding matrix Riccati equations.

The inductance L_{DQ} is included in the output matrix C, as will also be explained in detail below. It may also be expedient, and is proposed according to one embodiment, for the inductance L_{DQ} to be variable, and the latter can then form a further input variable for the observer block 426.

A reference current i^{ref} is now determined in the reference block 428 with the aid of the rotor flux ψᵣ observed in this manner. This reference current is a vector having four components here and has current values which can be set in order to obtain a desired generator torque, namely in particular a generator torque which does not have any harmonics or at least has few harmonics. This reference current i^{ref} is determined on the basis of the observed rotor flux ψᵣ and the desired torque tₑ^{ref} and is therefore represented in the reference block 428 as i^{ref}=f(ψᵣ, tₑ^{ref}).

If a variable inductance L_{DQ} is assumed, it is also included in the reference block 428 and, therefore, in the calculation of the reference current.

This reference current determined in this manner is then transferred to the back-transformation block 430. The composition of the reference current is also shown at the transfer arrow from the reference block 428 to the back-transformation block 430.

It should also be noted that the determination of the reference current i^{ref} may also be dependent on the output current i recorded and transformed in the transformation block 422. Accordingly, this current i is also represented as an input variable in the reference block 428.

In the back-transformation block 430, the reference current i^{ref} is then transformed back by means of two D/Q back-transformations, with the result that three current components are obtained for each of the two three-phase systems; namely a current value for each phase and each three-phase system. The result of the back-transformation block 430 is, therefore, the three current components i₁₁, i₁₂, i₁₃ for the first three-phase system and i₂₁, i₂₂ and i₂₃ for the second three-phase system. These current values are the desired values which, in this respect, are passed to the control units 418, with the result that the latter control the corresponding controlled diodes 432 in the rectifier 404 as much as possible in such a manner that the corresponding currents are set.

For this purpose, a calculation unit 434 may be provided or arranged upstream, which calculation unit provides the control units 418, for example, with specific values, for example specific current values, in which case the specific control of the relevant semiconductor switches 432 would then be assigned to the control units 418. In this case, other topologies of the implementation are also conceivable.

According to at least one specific embodiment a current control method which can be implemented, in terms of devices, by means of a controlled rectifier in conjunction with a six-phase, electrically or permanently excited synchronous machine is provided. The aim of the current control method is to impress a current waveform on the stator of the synchronous machine, which, taking into account the machine properties and the dynamic state of the synchronous machine, results in an electrical torque output which is as constant as possible.

The electrical torque of a six-phase generator having a double star connection with star points which are not connected can be expressed using a particular coordinate transformation from the phase coordinate system into a suitable four-axis double D/Q system. A possible coordinate transformation results from

f_{DQ}=T(θ)f_{abc},

where f_{DQ}=[f_{D1} f_{Q1} f_{D2} f_{Q2}]^{T} denotes the vector of D/Q coordinate variables (current or voltage) and f_{abc}=[fₐ₁ f_{b1} f_{c1} fₐ₂ f_{b2} f_{c2}]^{T} denotes the associated vector in phase coordinate variables, and

$$T ( θ ) = \frac{1}{\sqrt{2}} [ \begin{matrix}{T}_{P} ( θ ) & {T}_{P} ( θ - α ) \\ {T}_{P} ( θ + α + \frac{π}{2} ) & {T}_{P} ( θ - α - \frac{π}{2} )\end{matrix} ]$$

denotes the transformation matrix, where Tₚ(θ) in turn denotes the three-phase Park's or D/Q transformation matrix

$${T}_{P} ( θ ) = \sqrt{\frac{2}{3}} [ \begin{matrix}cos θ & cos ( θ - \frac{2 π}{3} ) & cos ( θ + \frac{2 π}{3} ) \\ - sin θ & sin ( θ - \frac{2 π}{3} ) & sin ( θ + \frac{2 π}{3} )\end{matrix} ] ,$$

and α denotes half of the phase shift between the two stator systems; that is to say 15° in this case.

Using this transformation, the electrical torque of the generator can be described by means of the following equation, which is described in S. Kallio, M. Andriollo, A.Tortella and J. Karttunen, “Decoupled d-q model of double-star interior permanent-magnet synchronous machines,” IEEE Transactions on Industrial Electronics, pp. 2486-2494, June 2013:

tₑ=nₚ(i_{Q}_{₁}Ψ*_{D}_{₁}+i_{Q}_{₂}Ψ*_{D}_{₂}−i_{D}_{₁}Ψ_{rQ}_{₁}−i_{D}_{₂}Ψ_{rQ}_{₂}),

where nₚ denotes the number of pole pairs of the generator, i*(*=D₁, D₂, Q₁ or Q₂) denotes the stator current in the corresponding coordinate axis in the double DQ system and ψ_{r*} denotes the magnetic flux in the corresponding DQ coordinate axis which is caused by the rotor of the generator (either by means of permanent magnets or an excitation winding), and

Ψ*_{D}_{₁}=i_{D}_{₁}(L_{D}_{₁}−L_{Q}_{₁})+Ψ_{rD}_{₁},

Ψ*_{D}_{₂}=i_{D}_{₂}(L_{D}_{₂}−L_{Q}_{₂})+Ψ_{rD}_{₂},

where L* (*=D₁, D₂, Q₁ or Q₂) in turn denotes a stator self-inductance, which is constant in the corresponding coordinate system, in the respective axis. The inductances can be determined in advance for all relevant operating points of the synchronous machine.

In order to provide a constant desired torque tₑ^{ref}, the following desired current value vector i^{ref}=[i_{D}_{₁}^{ref} i_{Q}_{₁}^{ref} i_{D}_{₂}^{ref} i_{Q}_{₂}^{ref}]^{T} can now be predefined in the four axes of the double DQ coordinate system, which is described in X. Kestelyn and E. Semail, “A vectorial approach for generation of optimal current references for multiphase permanent-magnet synchronous machines in real time,” IEEE Transactions on Industrial Electronics, pp. 5057-5065, November 2011:

$${i}^{ref} = \frac{J ( {Ψ}_{r} + {L}^{*} i )}{{‖ {Ψ}_{r} + {L}^{*} i ‖}^{2}} {t}_{e}^{ref} ,$$

where Ψᵣ=[Ψ_{rD}_{₁}Ψ_{rQ}_{₁}Ψ_{rD}_{₂}Ψ_{rQ}_{₂}]^{T}, i=[i_{D}_{₁}i_{Q}_{₁}i_{D}_{₂}i_{Q}_{₂}]^{T}, ∥ ∥ denotes the Euclidean norm and

$$J = [ \begin{matrix}0 & - 1 & 0 & 0 \\ 1 & 0 & 0 & 0 \\ 0 & 0 & 0 & - 1 \\ 0 & 0 & 1 & 0\end{matrix} ] , {L}^{*} = [ \begin{matrix}{L}_{{D}_{1}} - {L}_{{Q}_{2}} & 0 & 0 & 0 \\ 0 & 0 & 0 & 0 \\ 0 & 0 & {L}_{{D}_{2}} - {L}_{{Q}_{2}} & 0 \\ 0 & 0 & 0 & 0\end{matrix} ]$$

The actual control of the stator currents by means of the rectifier in order to achieve the desired values can be carried out, for example, by means of a hysteresis controller (tolerance band method).

However, such specification of the desired current values presupposes that the vector ψᵣ known. The magnetic flux can be measured only with a great amount of effort, but can be estimated using a state observer, which is fundamentally explained, for example, in : X. Xi, C.Changming and Z.Meng, “Dynamic Permanent Magnet Flux Estimation of Permanent Magnet Synchronous Machines,” IEEE Transactions on Applied Superconductivity, pp. 1085-1088, June 2010, and V. Anno and S. Seung-Ki “Design of flux observer robust to interior permanent-magnet synchronous motor flux variations,” IEEE Transactions on Industry Applications, pp. 1670-1677, September 2009.

A special feature lies in an equation form of the state observer, which differs from the previously published methods, and in the use of state observers to estimate the magnetic flux of six-phase electrical machines.

Like in Xi et al., IEEE Transactions on Industry Applications, pp. 1670-1677, September 2009, the state observer is in the form of an expanded Kalman filter. The synthesis of the Kalman filter requires a system of differential equations which describes the state of the observed system. In addition, two matrices Q and R which influence the behavior of the filter in the case of measurement and process noise are selected. In comparison with the formulation selected in Xi et al., IEEE Transactions on Industry Applications, pp. 1670-1677, September 2009, the selected formulation of the state space model has two important differences:

1. A six-phase synchronous machine is considered instead of a three-phase synchronous machine.

2. The basic principle of the state space description is selected in the approach described here in such a manner that observability of all states is ensured in contrast to Xi et al., IEEE Transactions on Industry Applications, pp. 1670-1677, September 2009. If there is no observability, there is no guarantee that the estimated states converge on the actual physical values in the time profile. Therefore, the solution of the equations used to synthesize the Kalman filter depends only on the adequate choice of the matrices Q and R.

The following state space description is used:

$$\dot{x} = Ax + Bu$$

$$y = Cx , \\ where$$

$$x = [ \begin{matrix}{Ψ}_{s}^{T} & {Ψ}_{r}^{T}\end{matrix} ] , y = i , u = {[ \begin{matrix}{u}_{{D}_{1}} & {u}_{{Q}_{1}} & {u}_{{D}_{2}} & {u}_{{Q}_{2}}\end{matrix} ]}^{T}$$

$$and$$

$$A = [ \begin{matrix}- ω j - {R}_{s} {L}_{DQ}^{- 1} & {R}_{s} {L}_{DQ}^{- 1} \\ {0}_{4 4} & {0}_{4 4}\end{matrix} ] , B = [ \begin{matrix}- {I}_{4} \\ {0}_{4 4}\end{matrix} ] , C = [ \begin{matrix}{L}_{DQ}^{- 1} & - {L}_{DQ}^{- 1}\end{matrix} ] .$$

Therein, ω denotes the electrical angular velocity which can be calculated from the angle recorded by means of measurement, Rₛ denotes the stator winding resistance, and

$${L}_{DQ} = [ \begin{matrix}{L}_{D 1} & & & \\ & {L}_{Q 1} & & \\ & & {L}_{D 2} & \\ & & & {L}_{Q 2}\end{matrix} ] .$$

On the basis of this observable state space model and the adequate choice of the matrices Q and R, a filter matrix K automatically results, which filter matrix is used in a closed filter circuit (Kalman filter standard configuration) to estimate the magnetic flux states. The matrix Q should be selected in such a manner that its elements represent the covariances of the expected noise of the state variables, whereas R should be selected in such a manner that the elements represent the covariances of the expected measurement noise of the measured output variables. This is described, for example, in M. S. Grewal, A. P. Andrews: Kalman Filtering, 4th edition, New York: John Wiley & Sons, 2014. The current control method, therefore, ensures a constant electrical torque output of the synchronous machine using the derivation described above.

For the implementation in a control computer, the resulting filters are implemented in time-discrete form. In order to convert a time-continuous design into a time-discrete form, numerous methods are known, see for example M. S. Grewal, A. P. Andrews: Kalman Filtering, 4th edition, New York: John Wiley & Sons, 2014.

In addition to the application to a six-phase machine, it is also possible to apply the current control method to a three-phase machine. All of the variables cited above with the index DQ then relate to the conventional DQ variables for a three-phase system and the variables with the index D₂ or Q₂ are dispensed with.

1. A method comprising:
controlling a synchronous generator of a gearless wind turbine, the synchronous generator including an electrodynamic rotor and a stator for producing electrical power by rotating the rotor relative to the stator, wherein controlling the synchronous generator comprises:
generating a multiphase output current at the stator;
supplying the output current to a rectifier; and
controlling the output current using the rectifier such that a torque ripple of the generator is reduced.

2. The method according to claim 1, comprising superposing, by the rectifier, a current waveform on the output current.

3. The method according to claim 1, wherein the synchronous generator is a six-phase generator and the rectifier is a six-phase controlled rectifier.

4. The method according to claim 1, wherein the rotor has a magnetic rotor flux and the method comprises controlling the output current based on the rotor flux.

5. The method according to claim 4, comprising determining the rotor flux using a state observer, and wherein controlling the output current includes controlling the output current based on the rotor flux determined using the state observer.

6. The method according to claim 1, wherein:
the generator has six phases and the stator has a double star connection with star points which are not connected,
during operation, the generator has an electrical torque caused by an interaction of currents and fluxes, wherein the currents and fluxes are transformed into a double D/Q system with four axes using a coordinate transformation, each of the four axes having a stator current component and a rotor flux component, and
a desired current vector with a desired current for each of the four axes is predefined for predefining a constant desired torque.

7. The method according to claim 6, comprising:
determining four rotor flux components of the four axes; and
controlling the output current using a state space representation of the determined four rotor flux components.

8. The method according to claim 7, wherein the output current from the stator is controlled using the state space representation that allows determination of all rotor flux components and all stator flux components.

9. The method according to claim 6 wherein the rotor flux components are determined based on a representation in the transformed double D/Q system having four axes by a Kalman filter.

10. A generator unit comprising:
a synchronous generator of a gearless wind turbine; and
a rectifier coupled to the synchronous generator, wherein the synchronous generator unit is configured to control the synchronous generator using the method according to claim 1.

11. A wind turbine having the generator unit accroding to claim 10.

12. The method according to claim 6, wherein the stator flux components are observed based on a representation in the transformed double D/Q system having four axes by means of a Kalman filter.
